(19) United States
(12) Patent Application Publication
(10) Pub. No.: US 2023/0417486 A1
(43) Pub. Date: Dec. 28, 2023

(54) FREEZE DRYER AND METHOD FOR FREEZE DRYING

(71) Applicant: HOSOKAWA MICRON B.V., Doetinchem (NL)

(72) Inventors: Peter Gerardus Josephus VAN DER WEL, Doetinchem (NL); Olukayode Isaiah IMOLE, Doetinchem (NL)

(21) Appl. No.: 18/252,925

(22) PCT Filed: Nov. 12, 2021
(86) PCT No.: PCT/NL2021/050699

§ 371 Date: May 15, 2023

(30) Foreign Application Priority Data
Nov. 13, 2020 (NL) 2026893

(51) Int. Cl. F26B 5/06; F26B 25/00

(52) U.S. Cl. CPC F26B 5/06; F26B 25/007

(57) ABSTRACT

A freeze dryer is provided, which comprises a freeze-drying chamber having an inlet for allowing material to be dried to be introduced into the freeze-drying chamber and configured for being evacuated at least partially, and a vacuum source in fluid communication with the drying chamber and configured for evacuating the freeze-drying chamber at least partially. A vacuum fluid path is defined between the freeze-drying chamber and the vacuum source. The freeze dryer further comprises a collecting filter configured for collecting dried material from the freeze-drying chamber, which collecting filter is arranged outside the freeze-drying chamber and within the vacuum fluid path between the freeze-drying chamber and the vacuum source.

### BACKGROUND

The invention relates to a freeze-dryer with a freeze-drying chamber having an inlet for allowing material to be dried to be introduced into the freeze-drying chamber and configured for being evacuated at least partially, and a vacuum source in fluid communication with the drying chamber and configured for evacuating the freeze-drying chamber at least partially, wherein a vacuum fluid path is defined between the freeze-drying chamber and the vacuum source.

Such a freeze-dryer is for example known from EP 1 601 919 B1 disclosing a method and device for freeze-drying solutions and liquid containing solid substances, in which a vessel is applied having a downwardly conical shape with inside a rotating mixing member that moves with a small inter-space along the wall of the vessel.

### SUMMARY OF THE INVENTION

A disadvantage of the known freeze-dryer may be that the part of the material to be dried that is dried already remains within the freeze-drying chamber while drying the remaining of the material to be dried. Therefore, all product is continuously worked during the entire duration of the drying process through the action of the rotating mixing member. This is disadvantageous for applications where sensitivity to shear is of critical importance. For example, in the freeze drying of probiotics and other living cells or in the freeze drying of spherical PLGA-based formulations.

Another disadvantage may be that the available heat transfer area is used inefficiently, due to decreasing product volume as the freeze-drying progresses.

It is an object of the present invention to ameliorate or to eliminate one or more disadvantages of the known freeze-dryer, to provide an improved freeze-dryer or to at least provide an alternative freeze-dryer.

According to a first aspect, the invention provides a freeze dryer, comprising:
a freeze-drying chamber having an inlet for allowing material to be dried to be introduced into the freeze-drying chamber and configured for being evacuated at least partially; and
a vacuum source in fluid communication with the drying chamber and configured for evacuating the freeze-drying chamber at least partially, wherein a vacuum fluid path is defined between the freeze-drying chamber and the vacuum source,
wherein the freeze dryer further comprises a material collector configured for collecting dried material from the freeze-drying chamber, which material collector is arranged outside the freeze-drying chamber and within the vacuum fluid path between the freeze-drying chamber and the vacuum source.

During use, the vacuum source evacuates the freeze-drying chamber at least partially and during freezing of the material to be dried, fine ice particles will be formed from the initial material to be dried. Once pressure is low enough, the ice particles formed begin to sublime. As sublimation progresses, a vapor flow is present between the freeze-drying chamber and the vacuum source, thereby passing the material collector. While the vapor flows towards the vacuum source, the individual ice particles shrink in size, resulting in the release of a powdery dust of the material. The powdery dust flows towards the material collector, where the powdery dust is collected from the vapor flow. As a result, the vapor flow downstream of the material collector comprises substantially no powdery dust anymore, since the powdery dust is collected by the material collector. Since the material to be dried is removed from the freeze-drying chamber when the material has been dried, the dried material is worked as short as possible, therewith advantageously reducing or in the ideal case eliminating the risk of dried material getting damaged due to a shear applied thereto.

A further advantage may be that since material is removed from the freeze-drying chamber when it is dry, the remaining material within the freeze-drying chamber is still wet. The dried material, therefore, does no longer occupy a part of the heat transfer area present within the freeze-drying chamber, resulting in an improved efficiency in using the available heat transfer area.

In an embodiment, the material collector is arranged next to and/or beside the freeze-drying chamber. When the powdery dust of the dried material is collected by the material collector, the powdery dust may fall downwards within the material collector, for example towards the bottom of the material collector, under influence of gravity. An advantage of this embodiment is that collection of the collected material from the material collector can be performed relatively simple.

In an embodiment, the material collector comprises a collector housing having an inlet in fluid communication with the freeze-drying chamber, a vacuum outlet in fluid communication with the vacuum source and a collector fluid path between the inlet and the outlet, and a collecting device provided between the inlet and the outlet and dividing the collector fluid path in a first path portion downstream of the collecting device and a second path portion upstream of the collecting device. In an embodiment thereof, the collecting device comprises a collecting filter screen provided between the inlet and outlet and dividing the collector fluid path in a first path portion downstream of the collecting filter screen and a second path portion upstream of the collecting filter screen. Collecting filter screens are used often for filtering dusts from a vapor flow and a lot of varieties of collecting filter screens are available. Therefore, a suitable collecting filter screen can be chosen advantageously in dependence of the material to be dried.

In an embodiment, the collector housing is provided with a material outlet in fluid communication with the first or second path portion of the collector fluid path and configured for allowing material collected by the collecting device to exit the collecting device. In an embodiment, the collector housing has a bottom, wherein the material outlet is arranged at or near the bottom of the collector housing. During use, when the powdery dust is removed from the vapor flow by the collecting device of the material collector, the collected powdery dust may fall downwards towards the material outlet and may exit the material collector via the material outlet, such that the collected powdery dust may be received below the material collector in an advantageous manner.

In an embodiment, the collector housing has a double-jacketed wall configured for receiving a heating fluid in order to heat fluid flowing through the collector fluid path and/or dried material collected within the material collector. Due to the double-jacketed wall, further drying of the collected powdery dust can be performed within the material collector.

In an embodiment, the freeze dryer comprises a collected material recipient configured for receiving material collected by the material collector and provided at or near the material collector. In a further embodiment thereof, the collected material recipient has a recipient body with a recipient chamber defined therein for receiving the collected material. In an even further embodiment, when the collector housing is provided with a material outlet in fluid communication with the first path portion of the collector fluid path and configured for allowing material collected by the collecting device to exit the collecting device, the collected material recipient is arranged at the material outlet in order to receive collected material from the material collector. During use, powdery dust transported from the freeze-drying chamber towards the material collected and subsequently received within the collected material recipient is prevented from coming into contact with the environment, therewith creating the possibility to perform a sterile drying process.

In an embodiment, the collected material recipient is configured for heating the collected material received therein. preferably the recipient body of the collected material recipient has a double-jacketed wall configured for allowing a heating fluid to circulate there through. An advantage of this embodiment is that further drying of the collected powdery dust can be performed, when necessary.

In an embodiment, the material collector is arranged at a first height, and the freeze-drying chamber is arranged at a second height, and/or wherein the material collector is provided on top of and/or above the freeze-drying chamber. In an embodiment thereof, the freeze dryer comprises a valve arranged within the vacuum fluid path and between the freeze-drying chamber and the material collector, wherein the valve is configured to be moved between an open position for allowing fluid flow from the freeze-drying chamber to the material collector, a closed position for preventing fluid flow from the freeze-drying chamber to the material collector, and/or an intermediate position for restricting fluid flow from the freeze-drying chamber to the material collector. An advantage of this embodiment is that a vapor flow towards the material collector, for example, can be stopped, restricted or allowed at any desired point of time.

In an embodiment, the valve is further configured for temporarily holding material collected by the material collector, when in the closed position. In a further embodiment, the freeze dryer comprises a fluid bypass conduit provided between the freeze-drying chamber and the material collector, and providing a bypassing fluid path between the freeze-drying chamber and the material collector which bypasses the valve. During use, the valve is intended to serve two purposes, namely firstly to allow, prevent or restrict vapor flow, and secondly to temporarily holding a material collected by the material collector from the vapor flow. The valve and bypass fluid bypass conduit advantageously enable recirculation of tiny ice particles during the sublimation phase. During freeze-drying, the valve between the material collector and freeze-drying chamber is in the open position during freezing and early stages of sublimation phase, allowing the tiny ice particles to be recirculated back into the freeze-drying chamber instead of being retained in the material collector. Since the valve is in its open position, the tiny ice particles can fall back into the freeze-drying chamber under influence of gravity. As the freeze-drying continues and more powdery dust is released from the freeze-drying chamber, the valve will be closed. From that moment, the released powdery dust has to move via the fluid bypass conduit along with the vapor flow to the material collector. The powdery dust collected from the vapor flow falls onto the valve, which is in its closed position, such that the collected powdery dust is temporarily hold by the valve. At the end of the freeze-drying process, the valve is moved into its open position, such that the powdery dust held by the valve is re-introduced into the freeze-drying chamber. Optionally, the re-introduced powdery dust undergoes “secondary” drying and/or is removed from the freeze-drying chamber. This is advantageous, since the available heat transfer area is utilized more efficiently.

In an embodiment, the freeze dryer further comprises a purge inlet provided in fluid communication with the vacuum fluid path, preferably downstream of the material collector, wherein the purge inlet is configured to be connected to a purge source in order to allow a blow pulse to be provided to the material collector. As the material collector is used for collecting powdery dust from a vapor flow, the material collector, for example a filter screen of the material collector, might get obstructed by the collected powdery dust. By providing a blow pulse to the material collector, preferably in a direction opposite to the flow direction of the vapor flow, any powdery dust is blown out of the material collector, therewith preventing advantageously the material collector from getting clogged.

In an embodiment, the freeze dryer comprises a substantially conical vessel, preferably having a downwardly conical shape, in which the freeze-drying chamber is defined, and an agitating member arranged within the freeze-drying chamber and configured for agitating material introduced into the freeze-drying chamber. The agitating member advantageously prevents the material to be dried from freezing into a solid mass of ice.

In an embodiment, the substantially conical vessel comprises a lid for closing off a top of the freeze-drying chamber, wherein the lid and/or the substantially conical vessel is provided with one or more blow nozzles having an outlet orientated into the freeze-drying chamber and configured for being connected to a gas source. During use, it is possible that material remains in the freeze-drying chamber at the end of the freeze-drying process, or is deposited at least partially onto the inner circumference of the freeze-drying chamber. By means of the blow nozzles debouching into the freeze-drying chamber, it is possible to introduce, for example shortly and intermittently, a gas bleed, for example air or nitrogen, into the freeze-drying chamber. Since the freeze-drying chamber is at least partially evacuated, expansion of the gas introduced into the freeze-drying chamber causes the remaining material to be blown off, therewith increasing advantageously the likelihood that remaining material is transported towards the material collector.

In an embodiment, the substantially conical vessel comprises a releasable outlet at the bottom thereof, which releasable outlet is usually closed and can be opened.

In an embodiment, all components of the freeze dryer are arranged for being contained and/or for being coupled to each other in a contained manner. Within the context of the invention the term “contained” means that the operations employed in the process to dry the materials are contained, which are therefore segregated from the surrounding environment. Thus, there is no need for an operator to have any direct access to the individual operations during operation.

According to a second aspect, the invention provides a material collector for use in a freeze dryer according to the first aspect of the invention.

According to the third aspect, the invention provides a method for freeze-drying or sublimation of a material to be dried by means of a freeze dryer, in particular a freeze dryer according to the first aspect of the invention, wherein the method comprises the steps of:
introducing a material to be dried into the freeze-drying chamber of the freeze dryer; and
evacuating the freeze-drying chamber at least partially by means of the vacuum source, in order to reduce the pressure within the freeze-drying chamber to or below a predetermined pressure level,
wherein the method further comprises the step of collecting dried material from the freeze-drying chamber by means of a material collector arranged outside the freeze-drying chamber and within the fluid path between the freeze-drying chamber and the vacuum source.

The method has at least the same advantages as described in relation to the freeze dryer according to the first aspect of the invention.

In an embodiment, the method comprises the step of reducing the temperature within the freeze-drying chamber to a temperature close to the freezing temperature of the material to be dried, preferably before the step of evacuating the freeze-drying chamber. In the context of the present patent application, a temperature close to the freezing temperature has to be understood as a temperature slightly above or slightly below the freezing temperature.

In an embodiment, the method comprises the step of introducing a gas bleed, such as an intermittent gas bleed, into the freeze-drying chamber, preferably at or near the end of the freeze-drying process.

In an embodiment, the method comprises the step of providing a blow-back pulse across the material collector, preferably periodically.

In an embodiment, the method comprises, at the end of the freeze-drying process, the steps of re-introducing material collected by the material collector into the freeze-drying chamber, and of post-blending the re-introduced material and remaining material within the freeze-drying chamber.

In an embodiment, wherein the material collector is arranged at a first height, and the freeze-drying chamber is arranged at a second height, and/or wherein the material collector is provided on top of and/or above the freeze-drying chamber, wherein the freeze dryer comprises a valve arranged within the vacuum fluid path and between the freeze-drying chamber and the material collector, wherein the valve is configured to be moved between an open position for allowing fluid flow from the freeze-drying chamber to the material collector, a closed position for preventing fluid flow from the freeze-drying chamber to the material collector, and/or an intermediate position for restricting fluid flow from the freeze-drying chamber to the material collector, and wherein the freeze dryer comprises a fluid bypass conduit provided between the freeze-drying chamber and the material collector, and providing a bypassing fluid path between the freeze-drying chamber and the material collector which bypasses the valve, the method comprises the steps of:
maintaining the valve in its open position during freezing and early stages of the sublimation phase, therewith enabling the tiny ice particles to be recirculated back into the freeze-drying chamber;
as drying progresses and more dust is released from freeze-drying chamber, moving the valve to its closed position, therewith forcing the released dust to move via the bypass conduit to the material collector; and
optionally, at or near the end of the drying process, moving the valve into its open position in order to enable the collected dust on the valve to be returned into the freeze-drying chamber.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached drawings, in which:

FIGS. 1A and 1B show an isometric view of a freeze dryer having a conical vessel and a material collector according to a first embodiment of the invention; and a cross sectional view of the conical vessel of FIG. 1A along line IA-IA, respectively;

FIGS. 2A and 2B show an isometric view of the material collector of FIG. 1A; and a cross sectional view of the material collector of FIG. 2A along line IIA-IIA;

FIG. 3A-3B show an isometric view of a freeze dryer having a conical vessel and a material collector according to a further embodiment of the invention; and a cross sectional view of the conical vessel of FIG. 3A along line IIIA-IIIA, respectively.

### DETAILED DESCRIPTION OF THE INVENTION

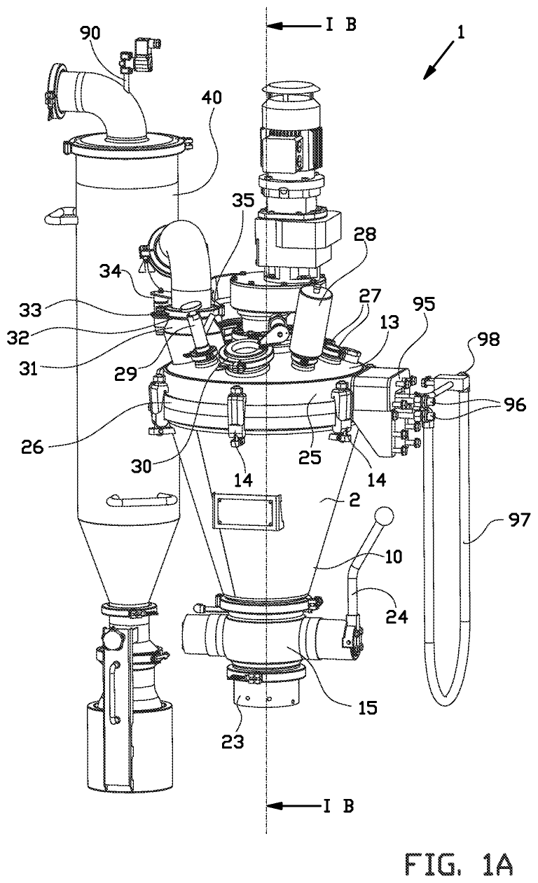

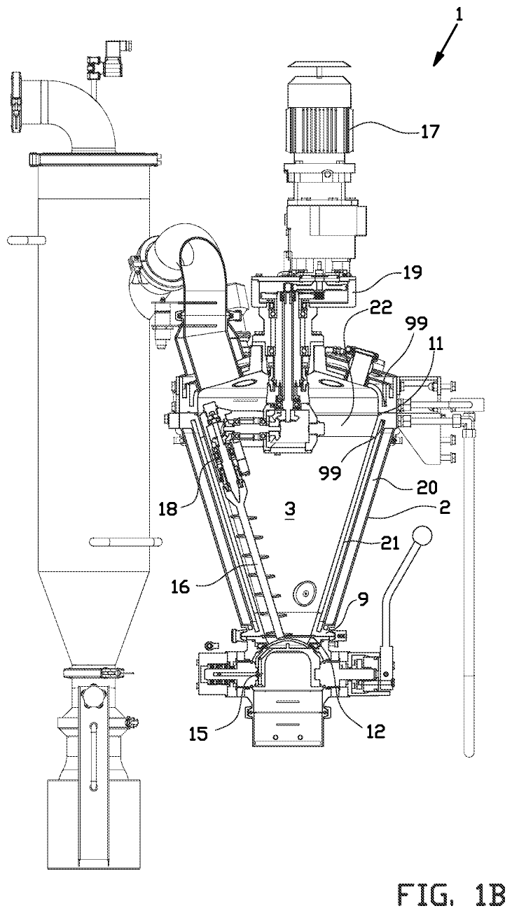

A freeze dryer 1 according to a first embodiment of the invention is shown in FIG. 1A. The freeze dryer 1 comprises a conical vessel 2 having a downwardly conical shape, in which a freeze-drying chamber 3 is defined. The conical vessel 2 has a conical shaped vessel wall 10 with an open top side 11 and an open bottom side 12, opposite to the open top side 11. A top lid 13 is arranged at the open top side 11 of the conical shaped vessel wall 10 for closing off the top side 11 thereof. The top lid 13 is fixed at the open top side of the conical shaped vessel wall 10 by means of a number of clamping screws 14. A releasable outlet 15 is arranged at the open bottom side 12 of the conical shaped vessel wall 10 for closing off the open bottom side 12 thereof. The releasable outlet 15 is configured for being usually closed and for being allowed to be opened when desired. As shown in FIG. 1B, the conical vessel 2 comprises an agitating member 16, in particular an agitating screw 16, for agitating material introduced into the freeze-drying chamber 3. The agitating member 16 is operatively connected to a drive 17 by means of a transmission 18 and a gear assembly 19, which are well-known to a person skilled in the art.

As shown in FIG. 1B, the conical shaped vessel wall 10 has a first compartment 20 and a second compartment 21, therewith forming a double-jacketed vessel wall 10, wherein the first and second compartments 20 and 21 are arranged concentric with respect to each other. Each of the first compartment 20 and the second compartment 21 is configured for receiving a heat-exchanging medium in order to cool and heat the contents of the freeze-drying chamber, depending on the phase during the freeze drying process. The conical shaped vessel wall 10 further includes an upper flange 22 for fixing the top lid 13 to the conical shaped vessel wall 10, and a lower flange 9 for fixing the releasable outlet 15 to the conical shaped vessel wall 10.

As further shown in FIGS. 1A and 1B, the releasable outlet 15, for example a ball segment valve, is provided with an attachment flange 23, for example, for attaching a non-shown receiving container to the freeze dryer 1. The releasable outlet 15 also has a handle 24 for moving the releasable outlet 15 between an closed position, in which the open bottom side 12 of the conical shaped vessel wall 10 is closed off by the releasable outlet 15, and an open position, in which the open bottom side 12 of the conical shaped vessel wall 10 is open and material is enabled to exit the freeze drying chamber 3. Such a releasable outlet 15 is known to the person skilled in the art. Alternatively, the releasable outlet 15 may be operated pneumatically.

As shown in FIG. 1A, the top lid 13 comprises a top lid body 25, which is substantially circular shaped, having a clamping flange 26 at the outer circumference thereof. The clamping flange 26 is configured for receiving the clamping screws 14 for clamping the top lid body 25 to the conical shaped vessel wall 10. At the upwardly facing side of the top lid body 25, the top lid body 25 is provided with a number of attachment flanges 27, for example, for attaching sensors or freeze dryer accessories to the freeze dryer 1. In this embodiment, an illumination source 28, a vent valve 29 and a sight glass 30 are each attached to the top lid body 25 a respective attachment flange 27 of the number of attachments flanges 27. The top lid body 25 further includes an outlet bus 31 with a fluid outlet channel extending therethrough and debouching into the freeze-drying chamber 3. The outlet bus 31 is provided with a first couple flange 32 at the end facing away from the freeze-drying chamber 3. The first couple flange 32 has a switch bracket 33 extending in a direction away from the first couple flange 32 and having a safety switch 34 provided thereon.

The freeze dryer 1 further comprises a non-shown vacuum source, such as a vacuum pump, which is operatively connected to the freeze-drying chamber 3, i.e. is in fluid communication with the freeze-drying chamber 3. The vacuum source is configured for, during use, reducing the pressure within the freeze-drying chamber to a predetermined pressure value, such as within the range of 5 mbar-0.01 mbar, depending on material/process conditions.

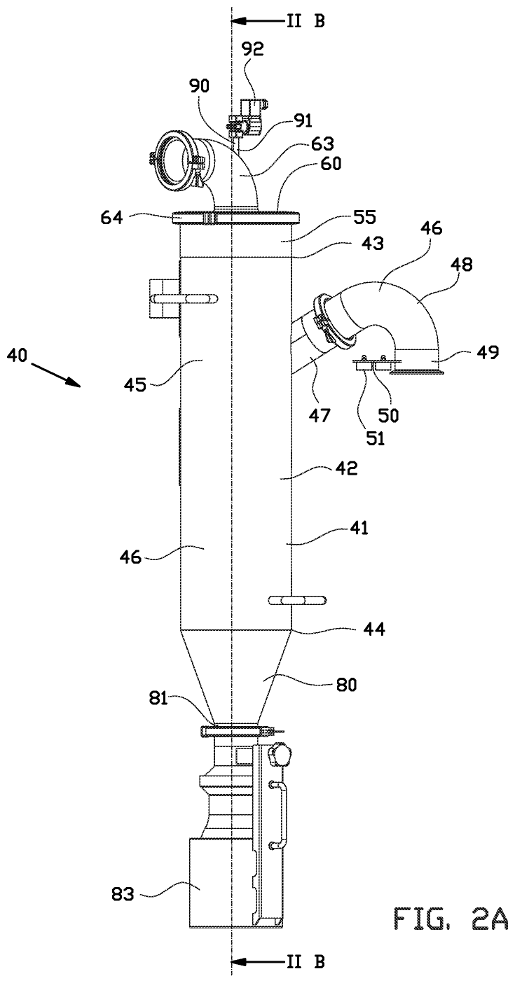

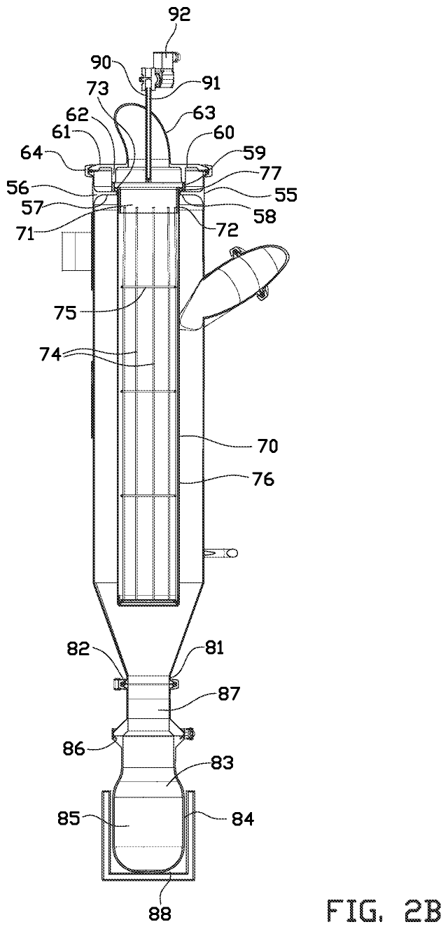

As shown in FIG. 1A, the freeze dryer 1 further comprises a material collector 40 which is shown in more detail in FIG. 2A. The material collector 40 comprises a circular cylindrical tube 41 having a tube body 42 with an upper end 43 and a lower end 44, opposite to the upper end 43 in longitudinal direction of the tube body 42. The tube body comprises a first body portion 45, also called upper body portion, and a second body portion 46, also called lower body portion. The material collector 40 is provided with a fluid inlet conduit 46 arranged at the first body portion 45 and debouching into the circular cylindrical tube 41. The fluid inlet conduit 46 has a first inlet conduit part 47 arranged at the circular cylindrical tube 41 and is orientated at a sharp angle with respect to the longitudinal direction of the circular cylindrical tube 41, such that fluid entering the circular cylindrical tube 41 is directed towards the second body portion 46. Furthermore, the fluid inlet conduit 47 has a second inlet conduit part 48 arranged at the side of the first inlet conduit part 47 facing away from the circular cylindrical tube 41, wherein the second inlet conduit part 48 is shaped as an elbow conduit part. The second inlet conduit part 48 is provided with a second couple flange 49, at the end thereof facing away from the first inlet conduit part 47. The second couple flange 49 has a magnet bracket 50 with a switching magnet 51 configured for cooperation with the safety switch 34 in order to determine whether the first and second couple flanges 32 and 49 are properly coupled. The coupling between the first and second couple flanges 32 and 49 is maintained by means of a coupling clamp 35.

The material collector 40 further comprises a filter holder 55 arranged at the circular cylindrical tube 41 at the upper end 43 thereof. The filter holder 55 has a circular cylindrical holder body 56 having substantially the same diameter as the circular cylindrical tube 41. A holding ledge 57 is provided at the inner circumference of the circular cylindrical holder body 56, which holding ledge 57 extends inwardly in a direction substantially transversal to the longitudinal direction of the circular cylindrical tube 41, while defining a filter through hole 58 at the center thereof. A clamping ring 59 is placed on top of the holding ledge 57, thereby covering the filter through hole 58.

The filter holder 55 further has a filter holder lid 60 arranged at the filter holder 55 at the side facing away from the circular cylindrical tube 41. The filter holder lid 60 includes a holder lid body 61 having a first side, facing upwardly in FIG. 2B, and a second side, opposite to the first side and facing downwardly in FIG. 2B. A pressing ring 62 is provided at the second side of the holder lid body 61, which pressing ring 62 extends towards the clamping ring 59 and is configured for applying a pressing force onto the clamping ring 59, during use. At the first side, the filter holder lid 60 has an outlet conduit 63 arranged for being connected to the non-shown vacuum pump.

As shown in FIG. 2B, the material collector 40 has a filter 70 configured for filtering a fluid flowing from the freeze-drying chamber 3 towards the non-shown vacuum pump. A shown, the filter 70 is placed with a fluid path defined between the fluid inlet conduit 46 and the outlet conduit 63. The filter 70 comprises a filter basket 71 with a main basket part 72 having a substantially annular shape and an abutting flange 73 configured for being arranged above the holding ledge 57, a number of basket rods 74 extending downwards from the main basket part 72, i.e. substantially parallel to the longitudinal direction of the circular cylindrical tube 41, and a number of transversal rods 75 extending between the basket rods 74. The filter 70 further comprises a filter screen 76 to be spanned around the filter basket 74, wherein the filter screen 76 has a reinforcing wire 77 provided at the top thereof. The reinforcing wire 77 is configured for being placed on top of the holding ledge 57 and below the abutting flange 73, such that, during use, the reinforcing wire 77 is clamped between the holding ledge 57 and the abutting flange 73 to prevent the filter from being removed unintentionally. The filter screen 76 is made from a screen material having a suitable mesh size in order to filter a desired material from the fluid flow from the fluid inlet conduit 46 to the outlet conduit 63, and divides the fluid path in a first path portion downstream thereof and a second path portion upstream thereof.

As shown in FIG. 2A, the material collector 40 comprises a funnel-shaped material outlet 80 at the lower end 44 of the circular cylindrical tube 41. The funnel-shaped material outlet 80 has an material outlet opening 81 defined by a material outlet opening flange 82, wherein the material outlet opening 81 is configured for enabling material filtered from a fluid by the filter 70 to exit the material collector 40, in particular from the second path portion of the fluid path therein.

The freeze dryer 1 has a collected material recipient 83 configured for receiving material collected by the material collector 40. The collected material recipient 83 has a recipient body 84 with a recipient chamber 85 defined therein for receiving material from the material collector 40. The recipient body 85 has a coupling portion 86 for being coupled to the material outlet opening flange 82 by means of an intermediate coupling piece 87. Around a part of the recipient body 84 is provided a heating device 88 for heating the contents of the recipient chamber 85.

As show in FIG. 1A and FIG. 2A, the freeze dryer 1 includes a purge inlet 90 with a purge conduit 91 being arranged at and extending into the outlet conduit 63 of the material collector 40. The purge inlet 91 has a connecting valve 92 configured for being connected to a non-shown purge source in order to provide a purge back flow to the filter 70 within the material collector 40, such that material is purged from the filter 70.

The freeze dryer 1 further comprises, as shown in FIG. 1A, a connecting manifold 95 having a number of connectors 96, for example, for being connected to a gas conduit 97 connected to a gas valve 98 configured for being connected to a non-shown gas source. At the side facing towards the freeze-drying chamber 3, the connecting manifold 95 is provided with blow nozzles 99 for allowing a gas to enter the freeze-drying chamber 3, therewith generating a gas bleed into the freeze-drying chamber 3.

During use, a material to be dried or a mixture of materials to be dried is introduced into the freeze-drying chamber 3. After introducing the material or mixture, the top lid 13 is closed and subsequently the temperature within the freeze-drying chamber 3 is lowered to a temperature close to and above the freezing temperature of the material or the mixture, by introducing a heat-exchanging medium into the double-jacketed vessel wall 10. Optionally, the material or mixture is precooled, or pre-frozen into granular ice particles before being introduced into the freeze-drying chamber 3, or is pre-frozen or precooled by means of cooling the material or mixture by means of the double-jacketed vessel wall 10.

The cooling step is followed by a controlled lowering of the pressure within the freeze-drying chamber 3 by means of the non-shown vacuum pump, until it approaches a pressure suitable for sublimation/freeze drying. The suitable pressure depends on the product and process characteristics, but might be in a range between 0.1 and 3 mbar. The reduction in the pressure within the freeze-drying chamber 3 causes a corresponding reduction in temperature within the freeze-drying chamber 3 and of the material or mixture, until freezing begins. During the freezing step, the motion of the agitating screw 16 ensures that the material or mixture does not freeze into a solid mass of ice, since it is desired to obtain fine, loose ice granules at the end of the freezing step. Optionally, in order to support sublimation, the temperature of the double-jacketed vessel wall 10 is slowly increased until the required maximum double-jacketed vessel wall 10 and/or product temperature is reached, which subsequently is maintained until drying is completed.

During the freezing step, fine ice particles are formed from the initial material or mixture. As sublimation progresses and the temperature of the double-jacketed vessel wall 10 is increased, vapor flows through from the freeze-drying chamber 3 towards the non-shown vacuum pump via the material collector. As this happens, the individual ice particles shrink in size leading to the release of fine (powdery) dust which remains as drying progresses. The powder is carried along with the vapor flow towards the material collector 40, where the dust is deposited on the filter screen 76 of the filter 70. Upon application of a filter blowback pulse via the purge inlet 90, the deposited dust is removed from the filter screen 76 and falls towards and into the collected material recipient 83. The collected material may be further dried within the collected material recipient 83 by the heating device 88 for heating the contents of the recipient chamber 85 before discharge.

It is possible that a fraction of the dried material or mixture is not transported towards the material collector 40 and remains freeze-drying chamber 3, or is deposited on the inner circumference of the freeze-drying chamber 3. It is possible to force the remaining material out of the freeze-drying chamber 3 towards the material collector 40. This can be done by a short, intermittent introduction of a gas bleed, e.g. air or nitrogen, into the freeze-drying chamber 3 via blow nozzles 99. Since the vacuum conditions are still present within the freeze-drying chamber, the expansion of the gas introduced into the freeze-drying chamber 3 causes the remaining dust to be blown off, thereby increasing the likelihood of transport to the filter. Gas bleed into the freeze-drying chamber 3 could also be used to optimize the process yield.

If required, a post-blending step may be carried out at the end of drying by collecting the material from the collected material recipient 83, and re-introducing it into the freeze-drying chamber 3. Blending is achieved by means of the agitating screw 16 so that a single batch is recovered at the end.

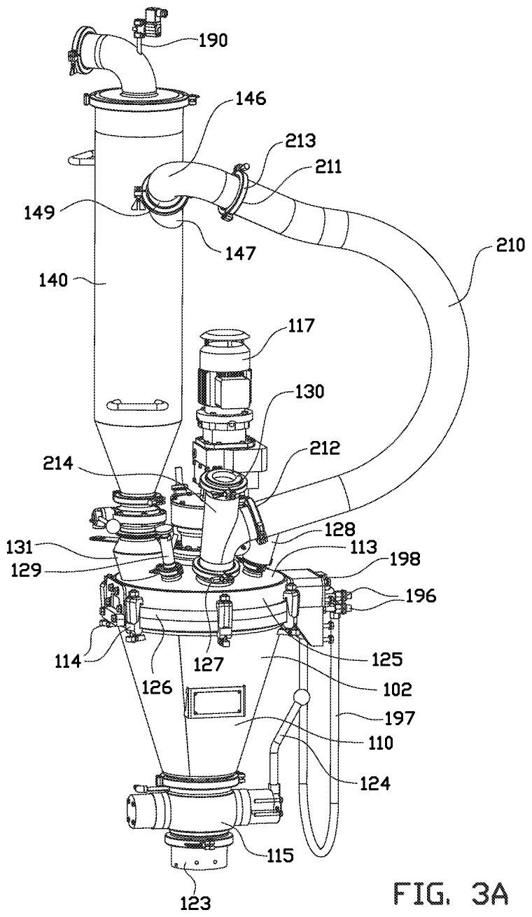

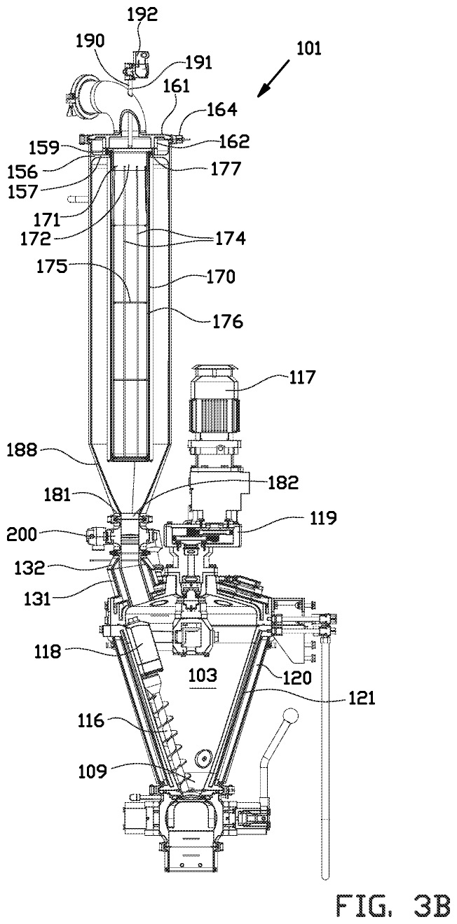

FIG. 3A shows another embodiment of the freeze dryer 101 according to the invention. In order to refrain from re-introducing features of the freeze dryer 101 which have been introduced already in relation to the first embodiment as described in respect of FIGS. 1A, 1B, 2A and 2B, corresponding features are indicated by the same reference numbers increased with 100.

The freeze dryer 101 as shown in FIG. 3A differs from the freeze dryer 1 as shown among others in FIG. 1A in that the material collector 140 is placed on top of the conical vessel 102. As shown in FIG. 3B, a valve 200, in particular a butterfly valve 200, is arranged at the first couple flange 132 of the outlet bus 131 at one end of the valve 200. The material opening flange 182 of the material collector 140 is arranged at the valve 200 at another end thereof, opposite to the one end thereof, such that a fluid can flow from the freeze-drying chamber 103 into the material collector 140 via the material outlet opening 181. The valve 200 is moveable between a closed state, in which no fluid can pass through the valve 200, and an open state, in which fluid might move from the freeze-drying chamber into the material collector 140 via the valve 200, or vice versa.

Furthermore, the freeze dryer 101 is provided with a bypass conduit 210 having a first conduit end 211 and a second conduit end 212, opposite to the first end 211. As shown in FIG. 3A, the bypass conduit 210, at the first conduit end 211 thereof, is coupled to the fluid inlet conduit 146, in particular the second couple flange thereof 149, of the material collector 140. The bypass conduit 210 is connected to a T-shaped connector 214 at the second conduit end 211 thereof. As shown, the T-shaped connector 214 is also provided with the sight glass 230.

The valve 200 and the bypass conduit 210 are configured for enabling recirculation of tiny ice particles during the sublimation phase. It is noted in the context of the present patent application that during the freezing and early sublimation stages, the vapor flow through the material collector 140 and towards the non-shown vacuum pump is at its highest. At this stage, some of the fine, loose ice granules could be being transported along with the vapor flow in the direction of the filter 170 of the material collector 140. The valve 200 between the freeze-drying chamber 103 and the material collector 140 is in the open position thereof during freezing and early stages of the sublimation phase, therewith enabling the tiny ice particles to be recirculated back into the freeze-drying chamber 103 instead of being retained in the filter 70. As drying progresses and more (powdery) dust is released from the ice matrix, the valve 200 is brought into its closed state. Following on closing the valve 200, the released dust is forced to move via the bypass conduit 210 along with the vapor flow to the filter 170 of the material collector 140. When the dust has been filtered from the vapor flow by the filter screen 176, the dust falls off the filter screen 176 onto the closed valve 200. At this stage of drying, the valve 200 serves as a dust recipient for temporarily holding the collected dust. The valve 200 is opened towards the end the drying process to enable the collected dust on the valve 200 to be returned into the freeze-drying chamber 103.

The determination of when to close the valve 200, for example, can be largely based on the onset of dust release which can be assessed either by monitoring pressure drop increase across the material collector 140, or tailored to coincide with the initiation of a filter blowback pulse, by visual inspection of the process, or any other process analytical tool. On the other hand, the determination of when to re-open the valve 200 towards the end of freeze-drying process depends on the decrease in vapor flow, or when the maximum double-jacketed vessel wall 110 and/or material or mixture temperature is reached, or when the pressure within the freeze-drying chamber 103 has decreased sufficiently. At the end of the drying process, a single product batch is discharged from the freeze dryer 101. Alternatively, the dust within the material collector 140 can also be collected separately from the material or mixture remaining in the freeze-drying chamber 103.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-27. (canceled)

28. A freeze dryer, comprising:
a freeze-drying chamber having an inlet for allowing material to be dried to be introduced into the freeze-drying chamber and configured for being evacuated at least partially; and
a vacuum source in fluid communication with the drying chamber and configured for evacuating the freeze-drying chamber at least partially, wherein a vacuum fluid path is defined between the freeze-drying chamber and the vacuum source,
wherein the freeze dryer further comprises a material collector configured for collecting dried material from the freeze-drying chamber, which material collector is arranged outside the freeze-drying chamber and within the vacuum fluid path between the freeze-drying chamber and the vacuum source.

29. The freeze dryer according to claim 28, wherein the material collector is arranged next to and/or beside the freeze-drying chamber.

30. The freeze dryer according to claim 28, wherein the material collector comprises a collector housing having an inlet in fluid communication with the freeze-drying chamber, a vacuum outlet in fluid communication with the vacuum source and a collector fluid path between the inlet and the outlet, and a collecting device provided between the inlet and the outlet and dividing the collector fluid path in a first path portion downstream of the collecting device and a second path portion upstream of the collecting device.

31. The freeze dryer according to claim 30, wherein the collecting device comprises a collecting filter screen provided between the inlet and outlet and dividing the collector fluid path in a first path portion downstream of the collecting filter screen and a second path portion upstream of the collecting filter screen.

32. The freeze dryer according to claim 30, wherein the collector housing is provided with a material outlet in fluid communication with the first or second path portion of the collector fluid path and configured for allowing material collected by the collecting device to exit the collecting device.

33. The freeze dryer according to claim 30, wherein the collector housing has a bottom, wherein the material outlet is arranged at or near the bottom of the collector housing.

34. The freeze dryer according to claim 30, wherein the collector housing has a double-jacketed wall configured for receiving a heating fluid in order to heat fluid flowing through the collector fluid path and/or dried material collected within the material collector.

35. The freeze dryer according to claim 28, comprising a collected material recipient configured for receiving material collected by the material collector and provided at or near the material collector.

36. The freeze dryer according to claim 35, wherein the collected material recipient has a recipient body with a recipient chamber defined therein for receiving the collected material.

37. The freeze dryer according to claim 32, wherein the collected material recipient is arranged at the material outlet in order to receive collected material from the material collector.

38. The freeze dryer according to claim 35, wherein the collected material recipient is configured for heating the collected material received therein,
preferably wherein the recipient body of the collected material recipient has a double-jacketed wall configured for allowing a heating fluid to circulate there through.

39. The freeze dryer according to claim 28, wherein the material collector is arranged at a first height, and the freeze-drying chamber is arranged at a second height, and/or
wherein the material collector is provided on top of and/or above the freeze-drying chamber.

40. The freeze dryer according to claim 39, comprising a valve arranged within the vacuum fluid path and between the freeze-drying chamber and the material collector,
wherein the valve is configured to be moved between an open position for allowing fluid flow from the freeze-drying chamber to the material collector, a closed position for preventing fluid flow from the freeze-drying chamber to the material collector, and/or an intermediate position for restricting fluid flow from the freeze-drying chamber to the material collector.

41. The freeze dryer according to claim 40, wherein the valve is further configured for temporarily holding material collected by the material collector, when in the closed position.

42. The freeze dryer according to claim 40, comprising a fluid bypass conduit provided between the freeze-drying chamber and the material collector, and providing a bypassing fluid path between the freeze-drying chamber and the material collector which bypasses the valve.

43. The freeze dryer according to claim 28, further comprising a purge inlet provided in fluid communication with the vacuum fluid path, preferably downstream of the material collector,
wherein the purge inlet is configured to be connected to a purge source in order to allow a blow pulse to be provided to the material collector; and/or
wherein all components of the freeze dryer are arranged for being contained and/or for being coupled to each other in a contained manner.

44. The freeze dryer according to claim 28, comprising a substantially conical vessel, preferably having a downwardly conical shape, in which the freeze-drying chamber is defined, and an agitating member arranged within the freeze-drying chamber and configured for agitating material introduced into the freeze-drying chamber.

45. The freeze dryer according to claim 44, wherein the substantially conical vessel comprises a lid for closing off a top of the freeze-drying chamber,
wherein the lid and/or the substantially conical vessel is provided with one or more blow nozzles having an outlet orientated into the freeze-drying chamber and configured for being connected to a gas source.

46. The freeze dryer according to claim 44, wherein the substantially conical vessel comprises a releasable outlet at the bottom thereof, which releasable outlet is usually closed and can be opened.

47. A method for freeze-drying or sublimation of a material to be dried by means of a freeze dryer according to claim 28, wherein the method comprises the steps of:
introducing a material to be dried into the freeze-drying chamber of the freeze dryer; and
evacuating the freeze-drying chamber at least partially by means of the vacuum source, in order to reduce the pressure within the freeze-drying chamber to or below a predetermined pressure level,
wherein the method further comprises the step of collecting dried material from the freeze-drying chamber by means of a material collector arranged outside the freeze-drying chamber and within the fluid path between the freeze-drying chamber and the vacuum source.

48. The method according to claim 47, comprising one or more of the following steps:
reducing the temperature within the freeze-drying chamber to a temperature close to the freezing temperature of the material to be dried, preferably before the step of evacuating the freeze-drying chamber;
introducing a gas bleed, such as an intermittent gas bleed, into the freeze-drying chamber, preferably at or near the end of the freeze-drying process;
providing a blow-back pulse across the material collector, preferably periodically;
at the end of the freeze-drying process, re-introducing material collected by the material collector into the freeze-drying chamber, and post-blending the re-introduced material and remaining material within the freeze-drying chamber;
wherein the material collector is arranged at a first height, and the freeze-drying chamber is arranged at a second height, and/or
wherein the material collector is provided on top of and/or above the freeze-drying chamber,
wherein the freeze dryer comprises a valve arranged within the vacuum fluid path and between the freeze-drying chamber and the material collector,
wherein the valve is configured to be moved between an open position for allowing fluid flow from the freeze-drying chamber to the material collector, a closed position for preventing fluid flow from the freeze-drying chamber to the material collector, and/or an intermediate position for restricting fluid flow from the freeze-drying chamber to the material collector, and
wherein the freeze dryer comprises a fluid bypass conduit provided between the freeze-drying chamber and the material collector, and providing a bypassing fluid path between the freeze-drying chamber and the material collector which bypasses the valve,
wherein the method comprises the steps of:
maintaining the valve in its open position during freezing and early stages of the sublimation phase, therewith enabling the tiny ice particles to be recirculated back into the freeze-drying chamber;
as drying progresses and more dust is released from freeze-drying chamber, moving the valve to its closed position, therewith forcing the released dust to move via the bypass conduit to the material collector; and
optionally, at or near the end of the drying process, moving the valve into its open position in order to enable the collected dust on the valve to be returned into the freeze-drying chamber.
